(19) United States
(12) Patent Application Publication
(10) Pub. No.: US 2014/0363795 A1
(43) Pub. Date: Dec. 11, 2014

(54) TRAVEL AND EDUCATION APPLICATION AND APPARATUS

(71) Applicant: Mind Gamez LLC, Excelsior, MN (US)

(72) Inventor: Mitchell ZAMOFF, Edina, MN (US)

(21) Appl. No.: 14/295,523

(22) Filed: Jun. 4, 2014

Related U.S. Application Data
(60) Provisional application No. 61/831,936, filed on Jun. 6, 2013.

(51) Int. Cl. G09B 19/00; G09B 7/06

(52) U.S. Cl. CPC G09B 19/0061; G09B 7/06
USPC 434/130

(57) ABSTRACT

The invention relates to a method and apparatus to provide information about a historical site, or other location of interest, through an interactive search/tour computer application particularly suited for site seeing experiences.

### RELATED APPLICATIONS

The present application claims priority to and incorporates by reference hereto U.S. Provisional Patent Application No. 61/831,936, filed on Jun. 6, 2013.

### BACKGROUND

### Field of the Invention

This invention relates to a method and apparatus for a travel and educational software application. In particular, the invention relates to a method and apparatus to provide information about a historical site, or other location of interest, through an interactive search/tour computer application particularly suited for site seeing experiences. Of course, a person of ordinary skill in the art will understand that the invention is not necessarily so limited.

### BRIEF DESCRIPTION OF THE FIGURES

FIG. 1 is an application screen shot of a splash screen.

FIG. 2 is an application screen shot of a mission screen.

FIG. 3 is an application screen shot of a theme selection screen.

FIG. 4 is an application screen shot of a hero display screen.

FIG. 5 is an application screen shot of a user information screen.

FIG. 6 is an application screen shot of a mission information screen.

FIG. 7 is an application screen shot of a hero selection screen.

FIG. 8 is an application screen shot of a biography screen.

FIG. 9 is an application screen shot of a game level selection screen.

FIG. 10 is an application screen shot of an oath screen.

FIG. 11 is an application screen shot of a game screen showing the first object to find.

FIG. 12 is an application screen shot of a guide screen.

FIG. 13 is an application screen shot of a next clue screen.

FIG. 14 is an application screen shot of a screen asking to user to identify if they have found the clue or not.

FIG. 15 is an application screen shot of an celebratory animation screen.

FIG. 16 is an application screen shot of a confirmation and education screen.

FIG. 17 is an application screen shot of a photographic option screen.

FIG. 18 is an application screen shot of an educational content screen.

FIG. 19 is an application screen shot of another educational content screen.

FIG. 20 is an application screen shot of a still further educational content screen.

FIG. 21 is an application screen shot of a next object search screen.

FIG. 22 is an application screen shot of a mission complete screen.

FIG. 23 is an application screen shot of an award screen.

FIG. 24 is an application screen shot of a screen showing other missions for the same site.

FIG. 25 is an application screen shot of a screen showing missions for other sites.

FIG. 26 is an application screen shot of an alternative site screen.

FIG. 27 is an application screen shot of an alternative level screen.

### DETAILED DESCRIPTION OF THE PREFERRED EMBODIMENTS

In the Figures, several screen shots of the application are shown. The application is computer implemented in one or more software modules executed by the CPU of a computing device. Preferably, the computing device is a mobile device, and most preferably a mobile device running an iOS operating system such as an iPad or iPhone, or Android devices. Of course, a person of ordinary skill will understand the application can be adopted for other devices and operating systems such as Windows/Microsoft, Blackberry, and the like.

The application can be downloaded to the device from, for example, the Apple App Store, or similar sources associated with other operating systems, or downloaded to the device in other manners—for example from a personal computer. The application comprises an interactive video game to teach history to children and teenagers as they tour some of the world's top historical sites, museums, churches, artistic sites, cultural sites, tourist attractions, natural history locations, or any other point of interest. Users assume the identities of a series of animated characters to tour the site looking for particular objects within the site, while the application provides the user with educational information about the site. The application is based around locating a number objects (each at a physical location within the site), which together comprise an overall mission.

The application is described in greater detail below in reference to several application screen shots, demonstrating one particular instance of the application. Of course, the application can be adapted for any number of other sites in a manner similar to what is described below.

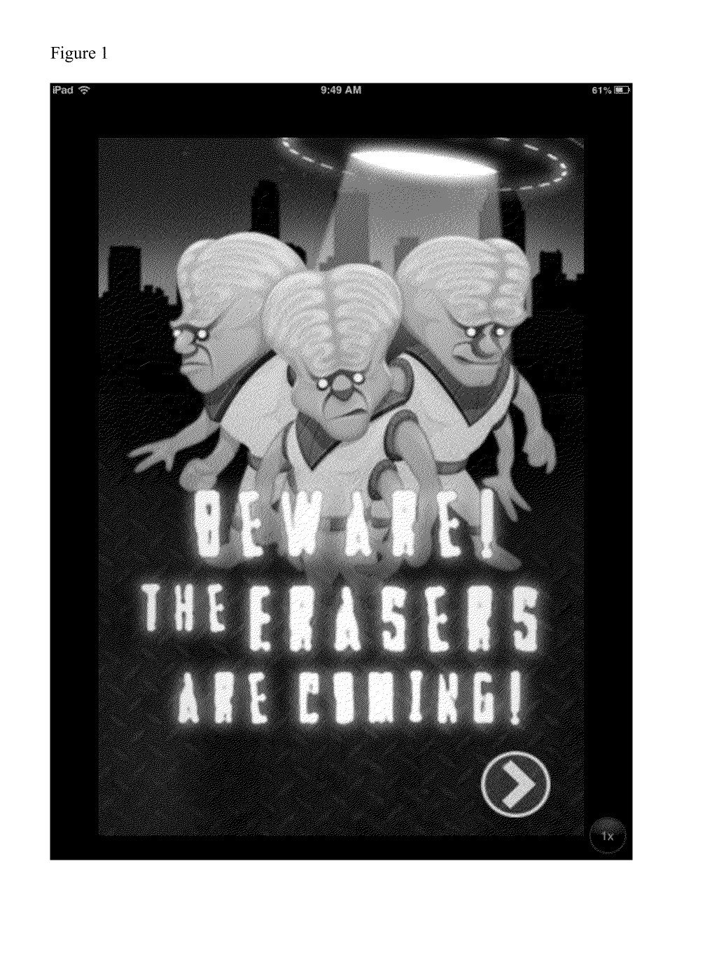

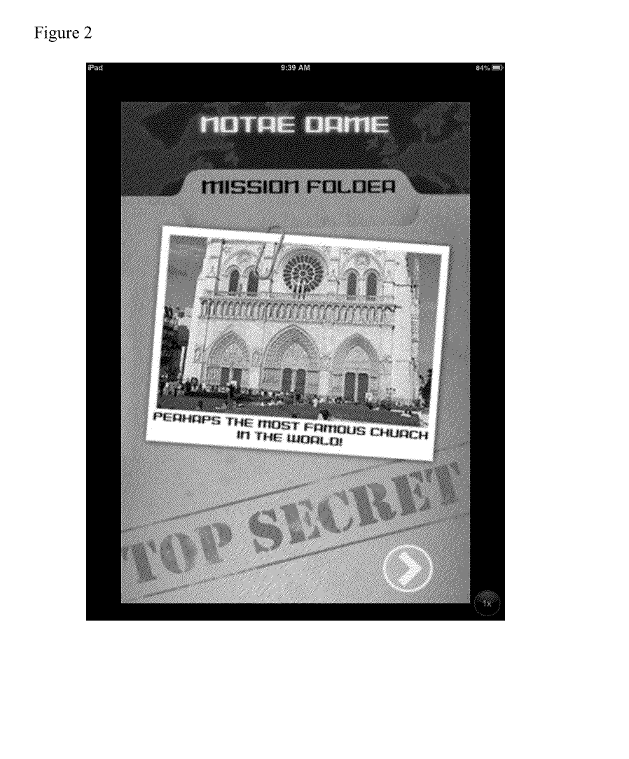

FIG. 1 shows an initial splash screen that is displayed after launching the application by selecting the History Hero icon from the device desktop/home screen. The screen depicts the Erasers (described in detail below). Selecting the arrow at the lower right displays the screen shown in FIG. 2.

FIG. 2 shows the opening mission screen of the application. The particular application described herein is in reference to the Notre Dame cathedral in Paris France. The invention is embodied in one or more similar applications each one specific to a different site, therefore the description below is applicable to all such applications.

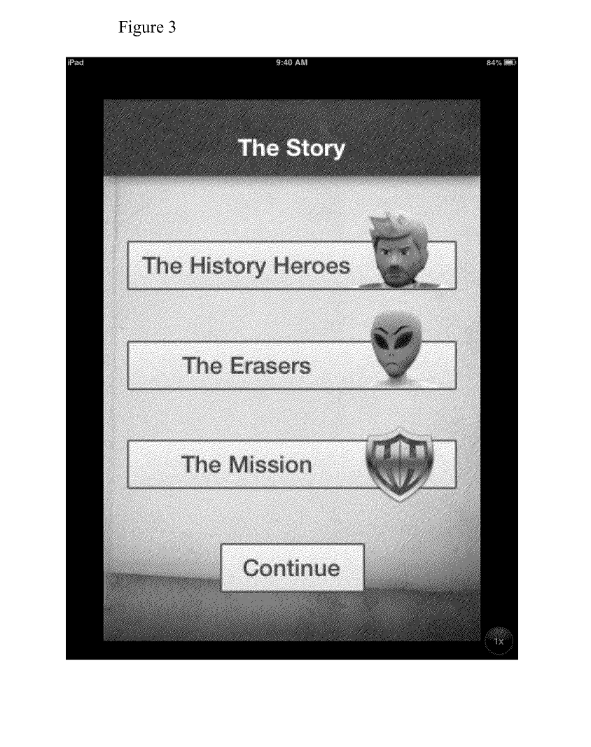

An application folder is displayed that shows the site, and the user selects the arrow in the lower right hand corner to proceed, which when selected displays the screen shown in FIG. 3.

FIG. 3 allows the user to select information about three thematic elements of the application, which are described below. One such element is the “History Hero” characters wherein the user will choose one of which to play the game. The application allows the user to select from multiple “History Heroes” each one represented by a unique animated persona and with an individualized history/back story. The History Hero is the game's protagonist. The next theme is the “Erasers.” The Erasers are the antagonist of the game. The last theme is the mission, which represents multiple objects that the user locates as part of the game, and in the course thereof gains educational information about the site. The gist of the game is that the History Heroes are going to help the user complete the game in order to prevent the Eraser's from erasing history associated with the reference site.

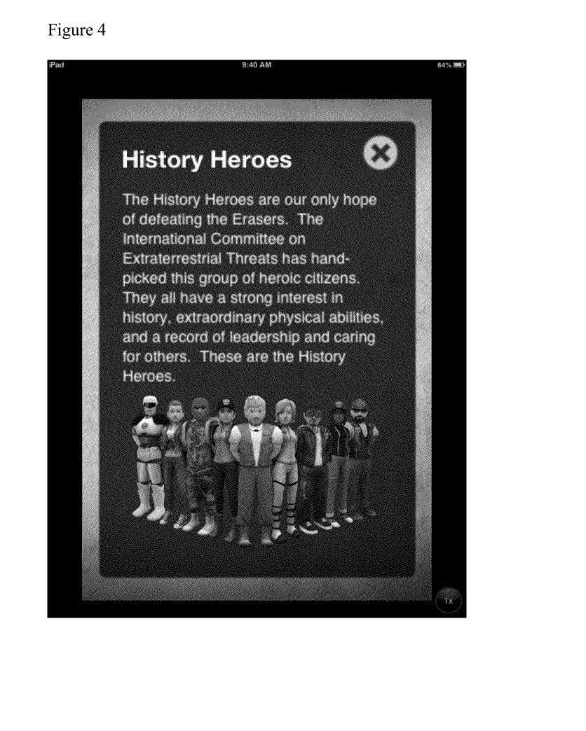

The screen shown in FIG. 4 appears after selecting the History Heroes tab shown in FIG. 3. The application displays the group of Heroes from which the user can select one as the game player. The screen also provides some information about the game and the relationship between the characters. The screen is closed by selecting the “X”, which returns control to the screen shown in FIG. 3.

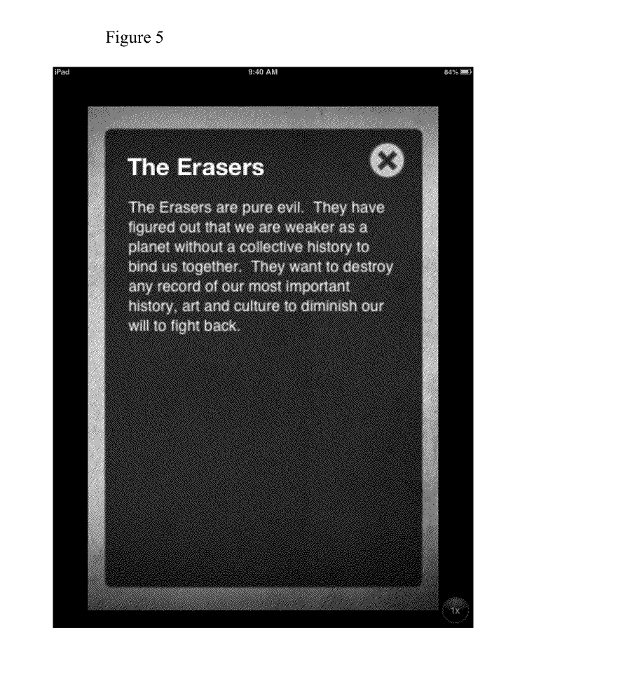

FIG. 5 appears after selecting the Erasers tab shown in FIG. 4. The screen provides the user with information about the Erasers and their role in the game. The screen is closed by selecting the “X”, which returns control to the screen shown in FIG. 4.

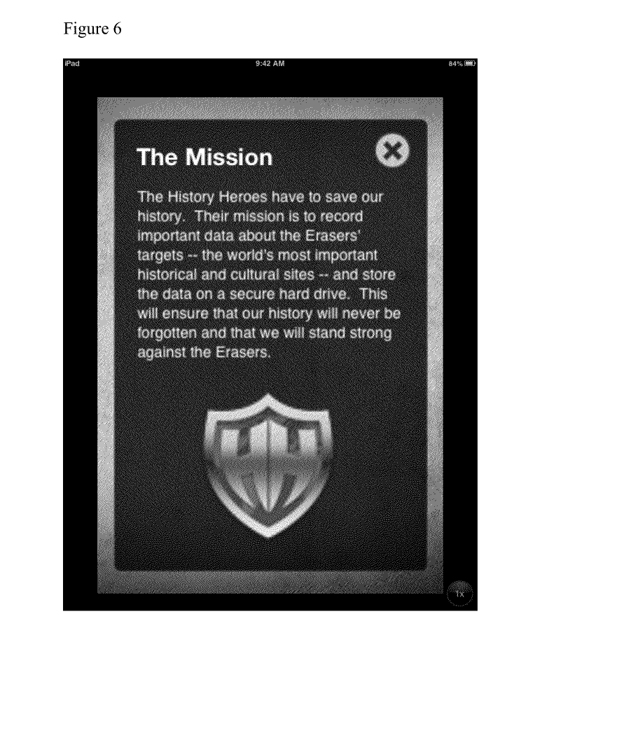

FIG. 6 appears after selecting the Mission tab shown in FIG. 3. The screen provides the user with information about the Mission of the game. The screen is closed by selecting the “X”, which returns control to the screen shown in FIG. 3.

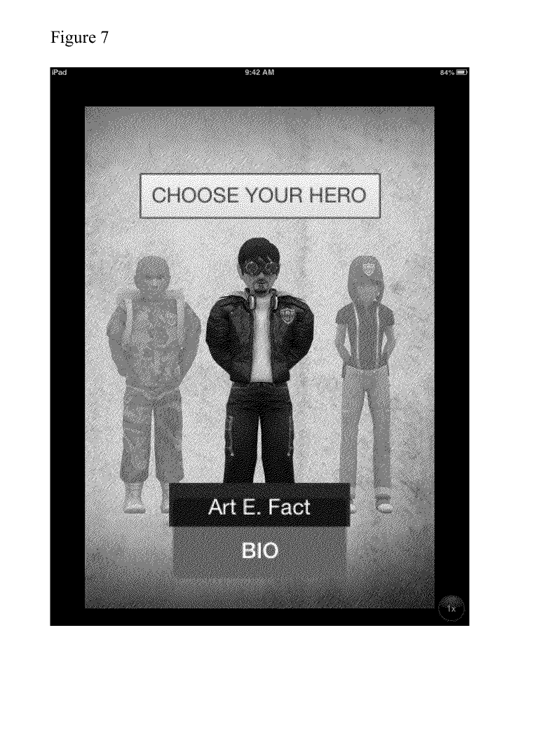

FIG. 7 is displayed after the user selects the “Continue” tab shown in FIG. 3. At this point, the user selects one of the various History Heroes. The user can view the different Heroes by sweeping their finger across the screen in the case of touch screen device such as the iPad or iPhone, or by similar technique for different devices. The name of the Hero is displayed along with a link to a biographical description of the particular Hero.

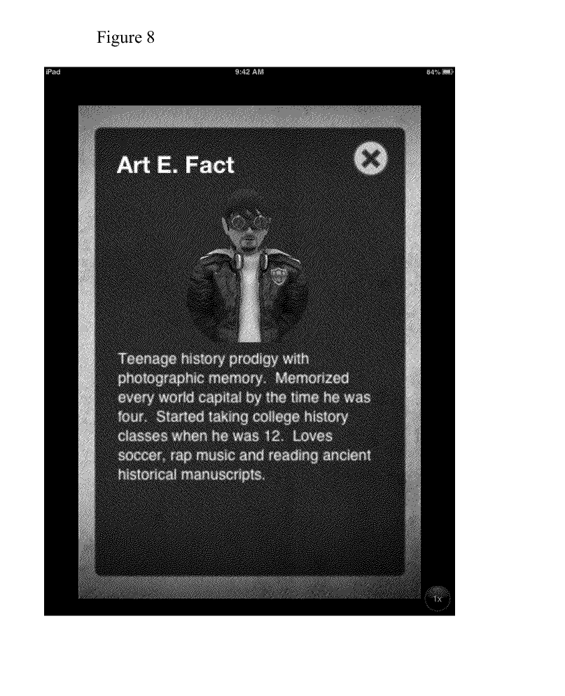

FIG. 8 is displayed after the user selects the bio tab shown in FIG. 7, which displays a short biography for the Art E. Fact Hero. Selecting the “X” returns control to the screen shown in FIG. 7.

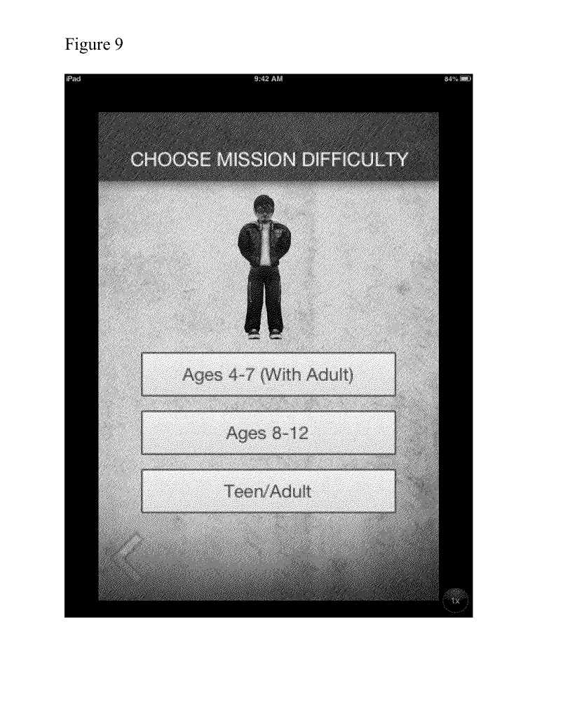

FIG. 9 is shown after the user selects a History Hero by pressing the name tab below a particular Hero. The screen asks the user to select a game level. The levels vary in difficulty based on the age of the user, and generally do so by varying the number of objects to find and the number of screens with object based educational content the user is asked to review. The age 4-7 level includes 10 objects and one content screen, the 8-12 level includes 15 objects and two content screens, and the teen/adult level includes 20 objects and three content screens. The arrow at the bottom left of the screen allows the user to navigate back to the previous screen. In the same manner, arrows at the bottom right allow the user to move to the next screen. The user can also navigate between screens by swiping the screen (at least on swipe enabled devices). This is a format that is used throughout the application.

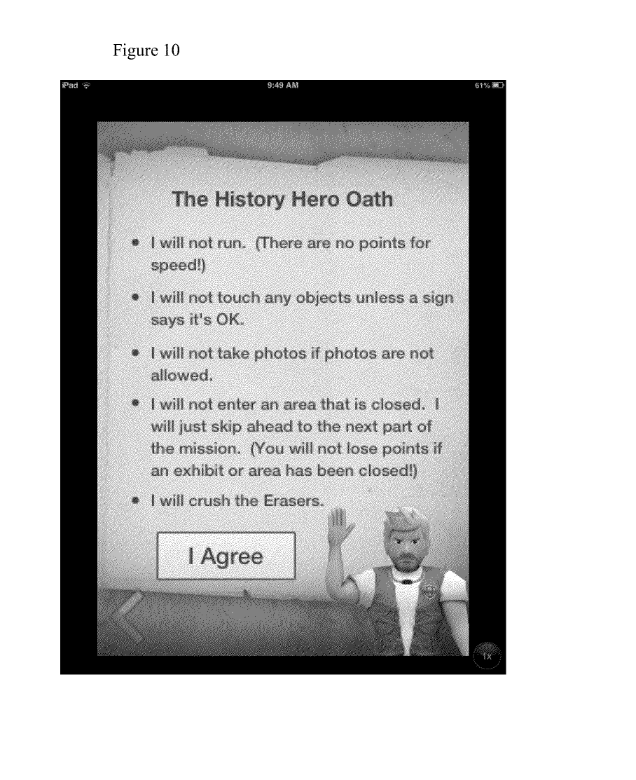

FIG. 10 shows the History Hero Oath that the user is asked to review, which generally asks the user to play safely and follow site rules, as well as enhances the drama of the game. The user presses the “Continue” tab to move to the next screen, which begins the game.

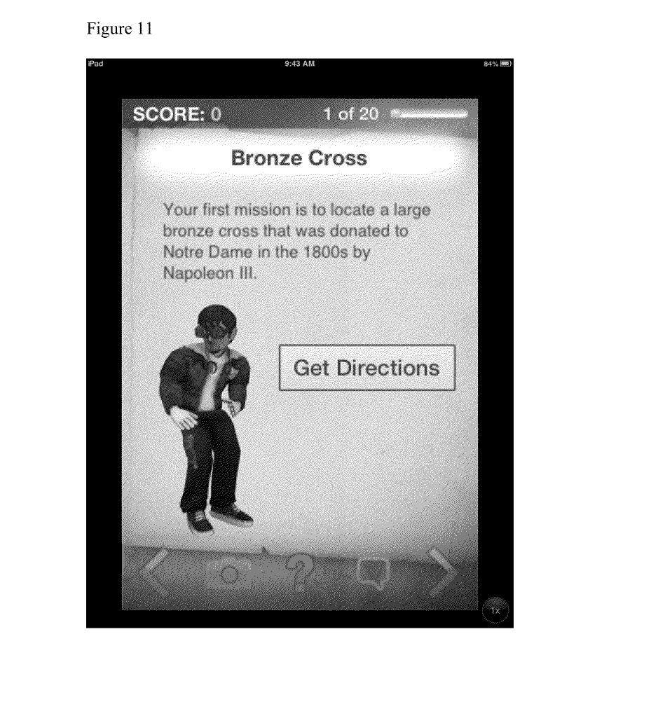

FIG. 11 shows the beginning of the actual game portion of the application. The game comprises a series of objects to find within the site. In this case, there are 20 objects to find, and the status of completion is shown in the upper right portion of the screen. As the user finds objects points are awarded, which are shown in the upper left portion of the screen. At the bottom of the screen a series of icons are available for the user to move to the next or prior screen, take a photograph of points of interest, seek help with the application, or send a message through the application.

The first object is described on the screen and asks the user to locate a point of interest within the site, namely, a large bronze cross. The user then selects the “Get Directions” tab for help in locating the cross.

As the user approaches the object, a pop may appear on the screen showing the Erasers and warning of their approach.

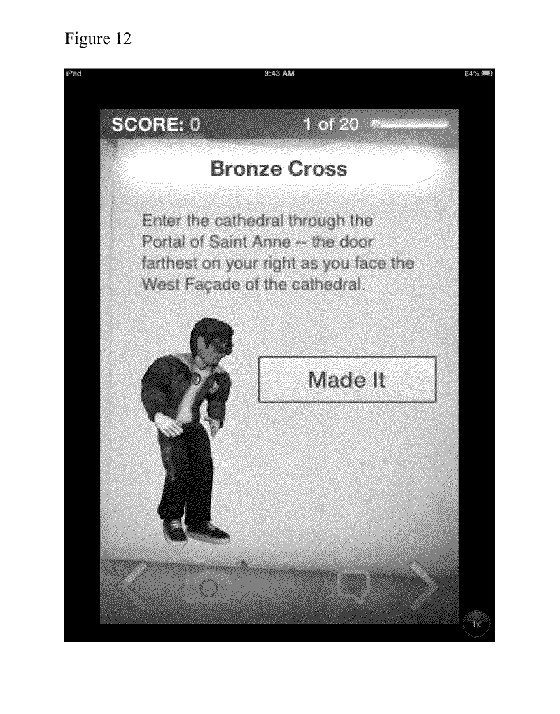

FIG. 12 shows initial directions to guide the user to the object. Once the user has made it to the proper location the “Made It” tab is selected for the next set of instructions.

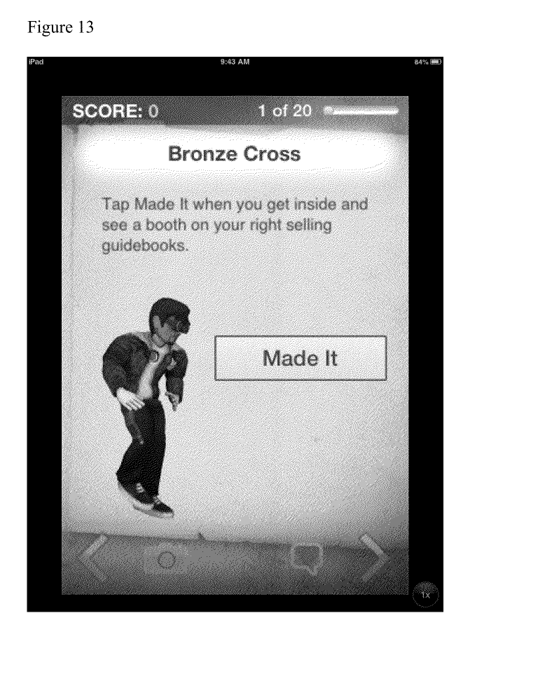

FIG. 13 provides the next clue in the search. The User selects the “Made It” tab to move to the next step.

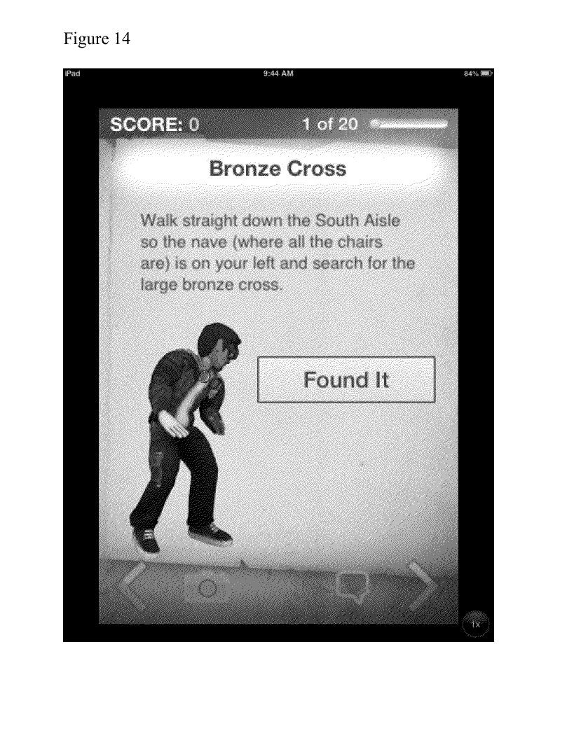

FIG. 14 provides the final directions to the cross, and asks the user to select “Found It” to indicate they have found the object.

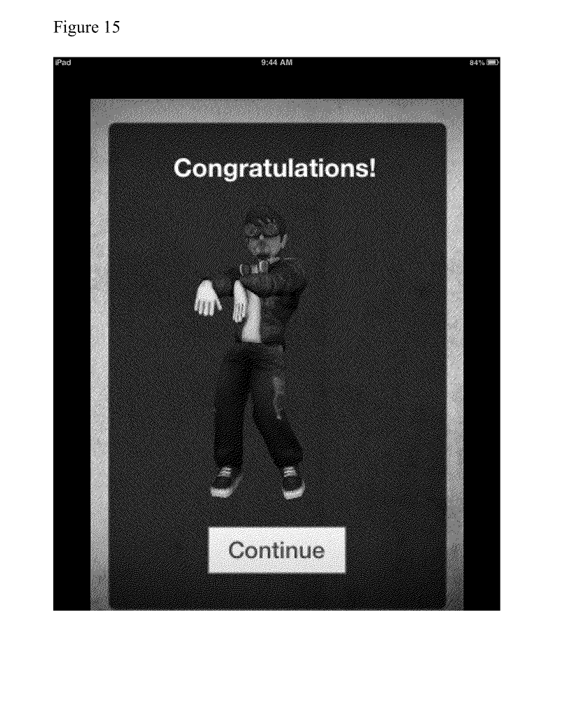

FIG. 15 shows an animation of the History Hero dancing, congratulates the user on completing the goal, and asks the user to select “Continue.” The user is also awarded points for finding the object. As the user progresses through the application and gains a certain level of points, up to four additional celebration dances become available and are displayed randomly on the screen. When new celebrations are available, a screen is displayed that asks the user to tap the screen to unlock the new celebration.

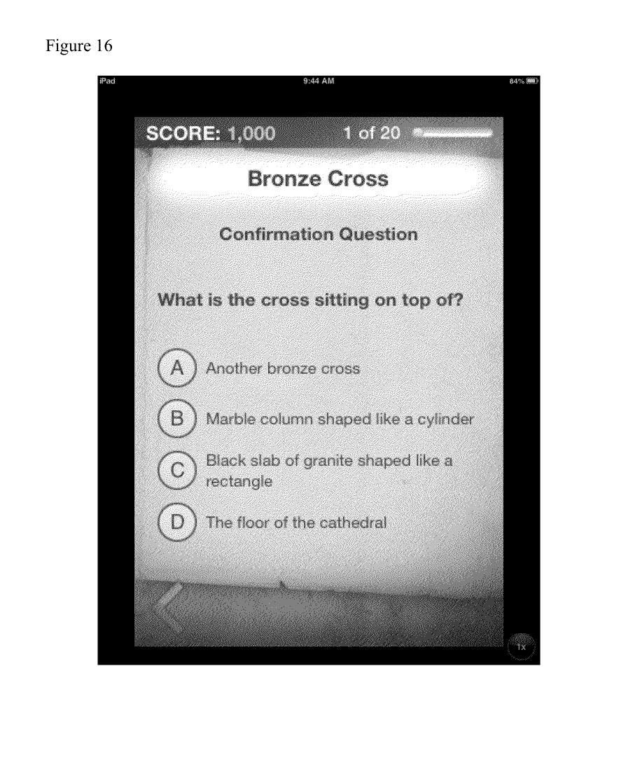

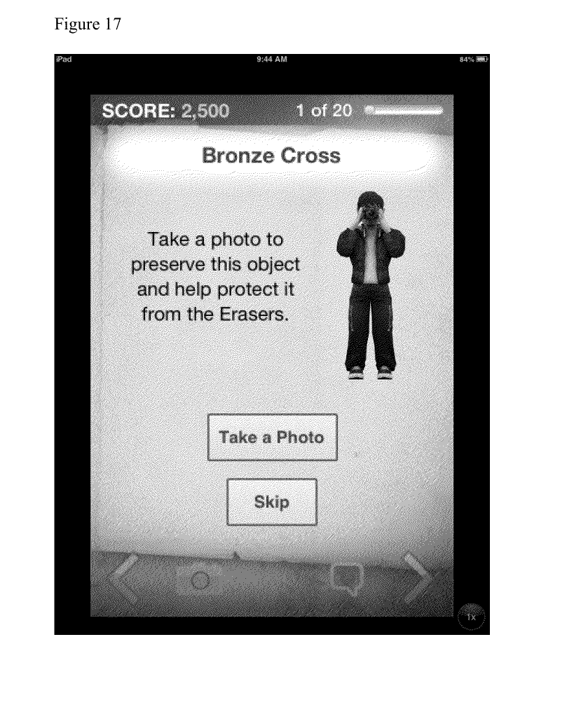

FIG. 16 shows a confirmation question screen designed to prompt the user to identify the object that is the subject of the mission. This ensures that that the user has actually found the object. Points are awarded for answering the question correctly. The amount of points varies based on the number of guess it takes the user to answer the question. After the confirmation question is answered a bonus question is displayed which also is based on the object. Once the correct answer(s) is/are entered, control passes to the screen shown in FIG. 17.

FIG. 17 shows a screen that allows the user to take a photograph with the device to memorialize the object. The user can also skip this screen if they like.

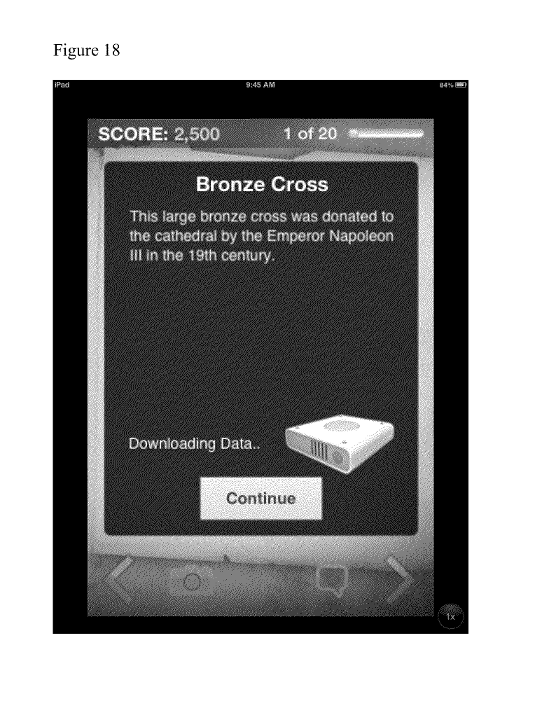

FIG. 18 shows a content screen that provides the user with information of an educational nature about the object found by the user, in this case the bronze cross. The application shows a data download animation, to simulate that history has been saved from the Erasers. In the 4-7 year level there is one content screen, two content screens in the 8-12 level, and three in the teen/adult level. The user selects “Continue” to move to the next screen.

An additional feature on this screen allows the user to rate the object from one to five stars by tapping stars on the screen.

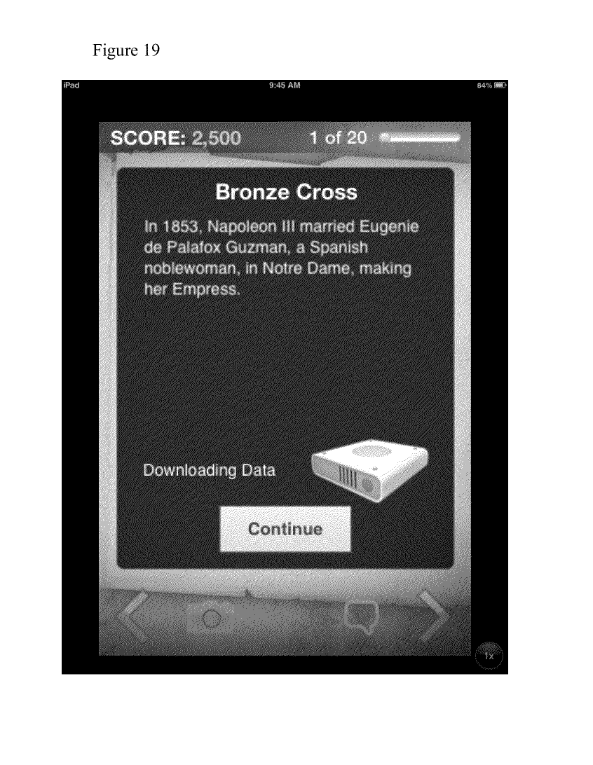

FIG. 19 shows the second content screen and repeats the process described in reference to FIG. 18, providing additional information about the object.

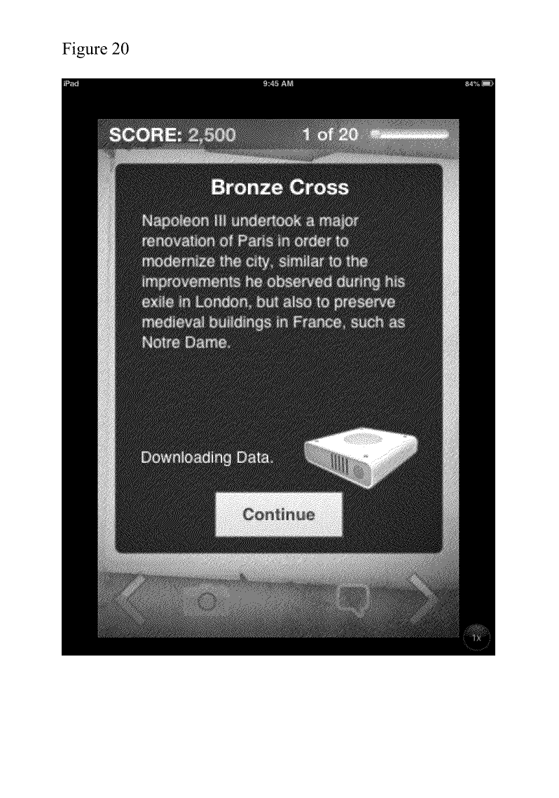

FIG. 20 shows the third content screen and repeats the process described in reference to FIGS. 18 and 19, providing additional information about the object. After this screen is displayed, the application asks the user a double bonus question based on the information displayed on the prior object content screens. The questions are designed to promote user retention of the content.

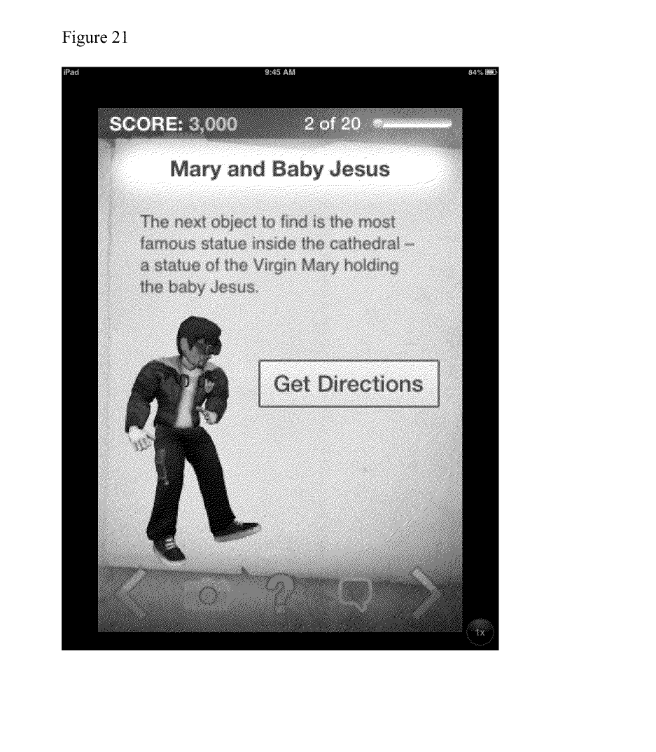

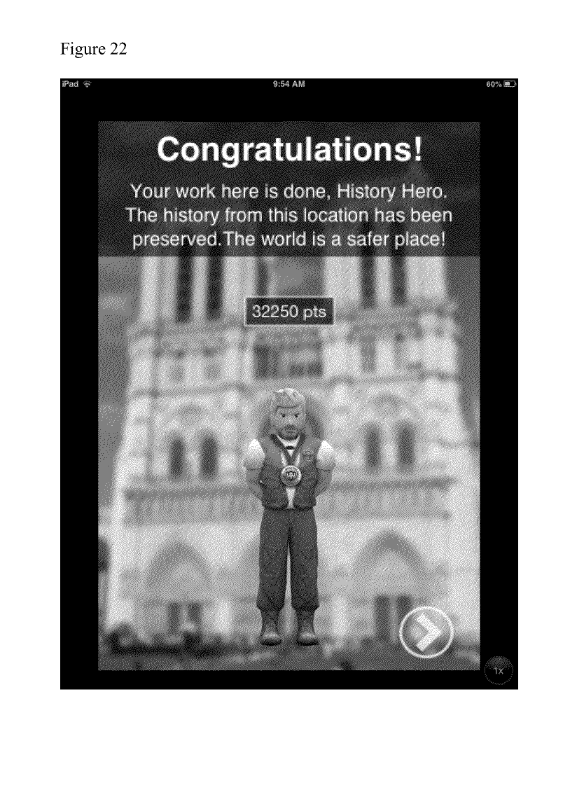

FIG. 21 shows the initiation of the next object search within the mission, wherein the process described above in relation to object 1 (find the bronze cross) repeats. Each object search includes directions, a confirmation questions, bonus question, content screens, and double bonus question based upon the content. Once all the objects have been found and saved, the screen in FIG. 22 is shown.

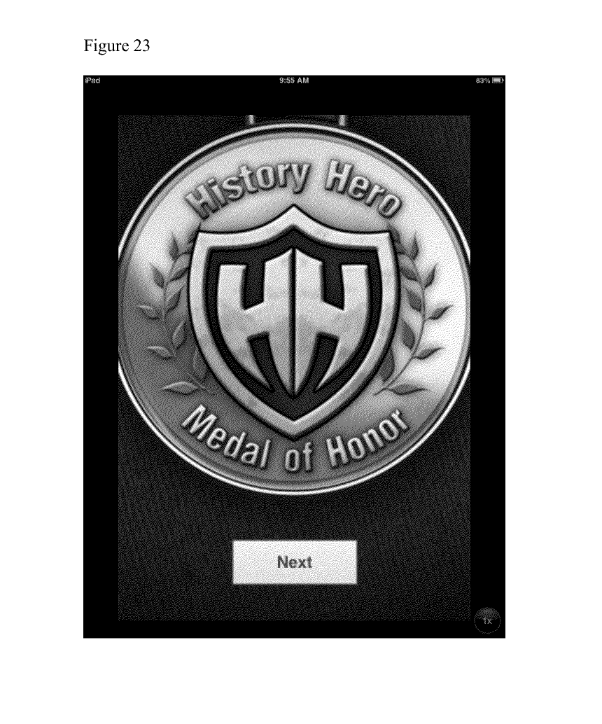

FIG. 22 indicates to the user that the mission has been completed, and shows the total score for the mission. Control passes to the screen shown in FIG. 23 after the user selects the “Continue” tab.

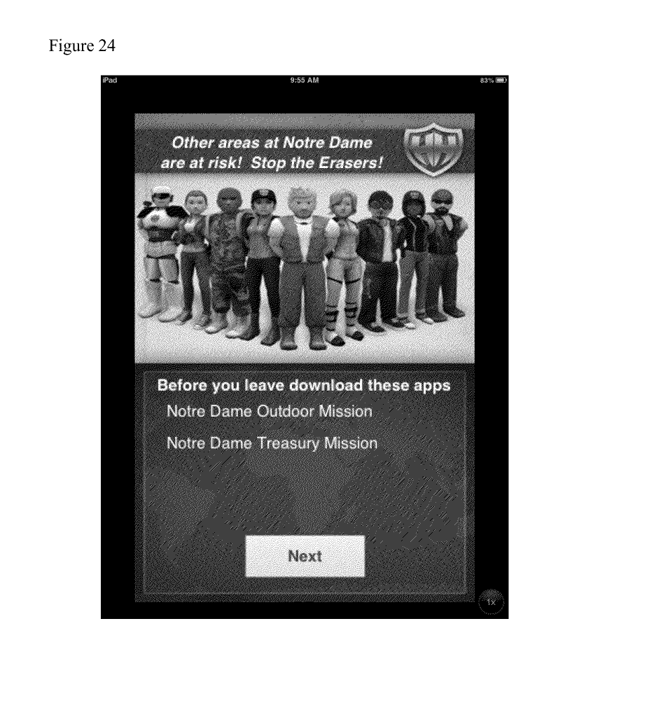

FIG. 23 displays an award for completing the mission. The user then selects “Next” to move to the screen shown in FIG. 24.

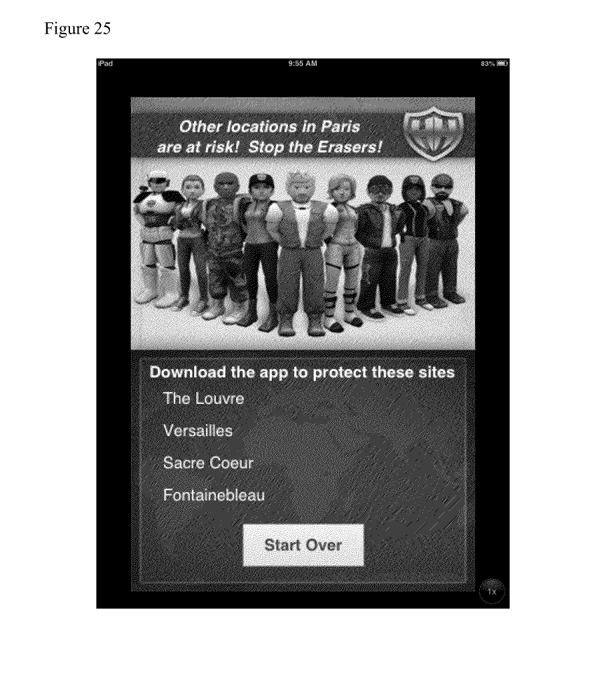

FIG. 24 shows the user other History Hero applications that relate to the same site, which they can download and/or complete. Control passes to the screen shown in FIG. 25 when the user selects the “Next” tab.

FIG. 25 shows the user other History Hero applications that relate to the same general area as the current site, which they can download and/or complete. The user can then start the game over, perhaps to play another level.

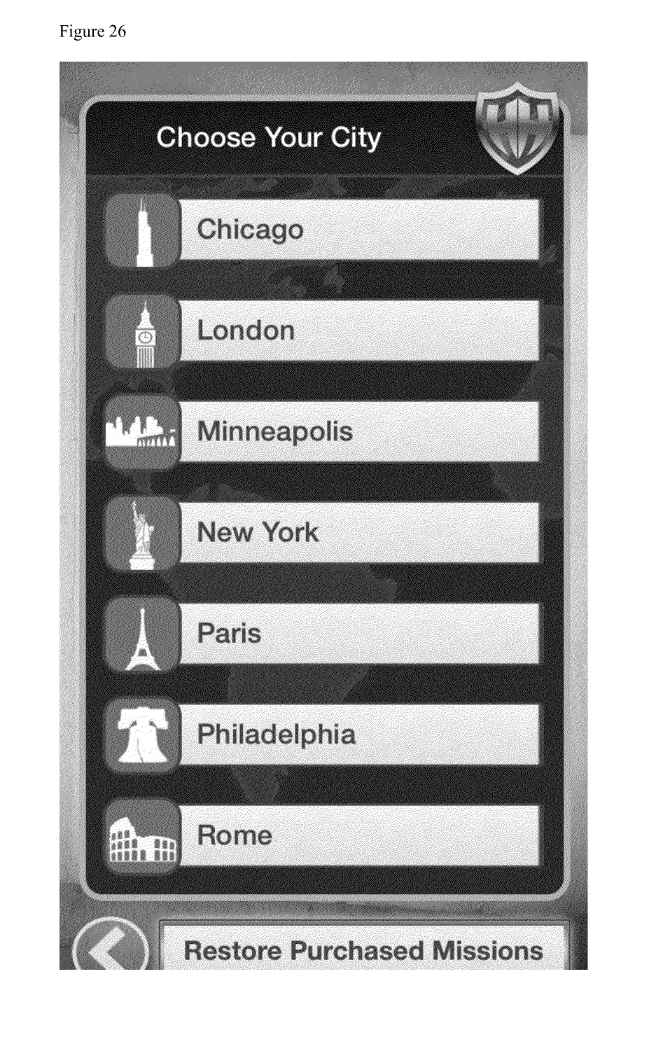

FIG. 26 shows an alternative site selection screen. The screen allows the user to selected missions based on the city involved. The screen would appear at the beginning of the application allowing the user to select the location where they are located. Control can pass to this screen after completion of a mission or series of missions in a particular location.

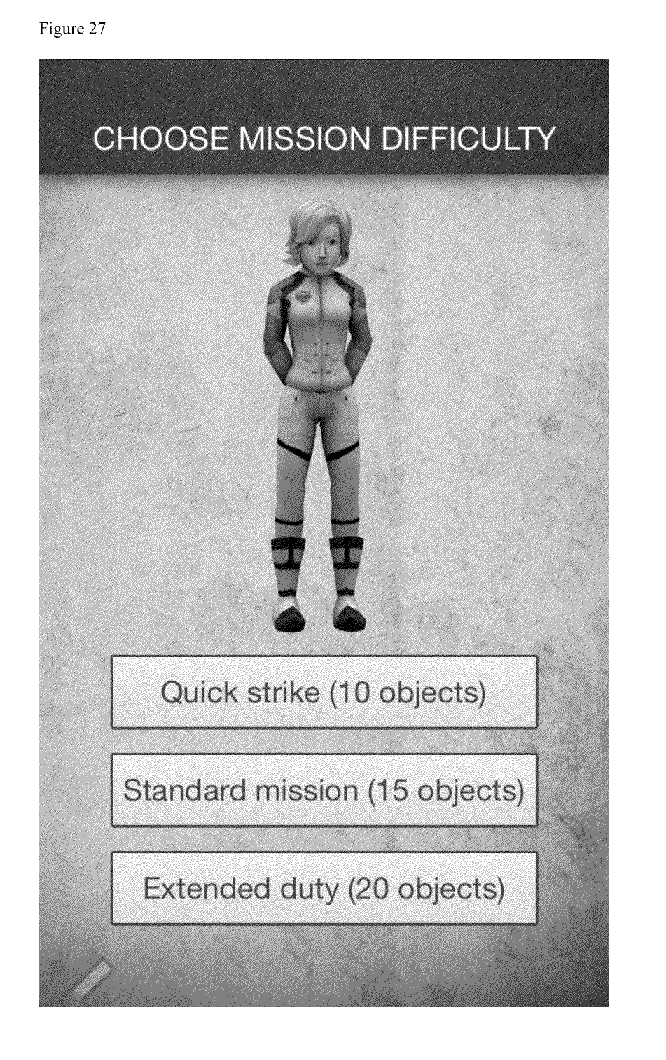

FIG. 27 shows an alternative difficulty screen. Similar, or as an alternative to, the screen shown in FIG. 9. The difficulty of the application can be controlled by choosing an appropriate level of objects to find. The lower the number of objects the quicker the mission can be accomplished and the more suitable it would be to younger users.

The present invention substantially overcomes the problems of the prior art by providing a computer based application that bridges the gap between travel and education, thereby bringing history to life for users (especially children) in a fun and interactive way at some of the world's top historical sites.

The present invention is an interactive video game to teach history to users, such as children and teenagers, as they tour the world's top historical sites. Developed in consultation with some of the nation's top teachers, History Hero brings history to life in a way that guidebooks and audio tours can't. Users of all ages—and their parents—take on interactive missions from around the world as guided by fanciful characters designed to promote the application.

The application is based around three primary age groups: ages 4-7 (with an adult companion); ages 8-12; and ages 13 and above. The application can be downloaded to a computing device, such as a mobile or handheld device like a smartphone or tablet computer, from one or more application stores (such as those made available for iOS or Android devices).

The missions are utilize the following format: after taking the oath, users are sent on a mission to find and save the location's top artifacts; upon finding artifacts, users are asked a multiple choice question depicting the artifact and are encouraged to take a photo (if allowed) for their album; once the artifact is documented, the application provides the user with an age-appropriate description of the artifact, developed with the help of teachers, in the form of data to be downloaded to a “secure hard drive” and the opportunity to answer a bonus question based on this educational data; as the users learn more about Earth's history, they are rewarded with points; upon successful completion of the mission, the user and their chosen persona receive a highest decoration—the Medal of Honor.

The application includes characters with the following personas.

Hunter Relik—Famous archaeologist and scientist who has uncovered some of the most important historic artifacts in the world. Invented special chemical compound that helps preserve ancient documents. Champion swimmer in college who qualified for the Olympics but chose to focus on science instead.

Ally N. Blast—Astronaut. Part of the first crew of astronauts stationed at the World Space Station to protect Earth from alien invasions. Responsible for intercepting two dangerous alien spacecrafts headed for Earth. Wrote a book about the history of space travel.

Scout Sonner—Soldier. Broke physical fitness records in basic training Led missions to recover stolen historical items from enemy forces. Won medal of honor for risking life to save original copy of his country's constitution. Father was a military historian.

Meg A. Pixel—Photographer. Her famous photos of historical churches and castles hang in galleries all around the world. Former police officer who specialized in recovering stolen computer data. Elite distance runner who has competed in six Boston Marathons.

Atlas Mapp—Biker and Motorcycle Shop Owner. Saved four passengers from burning car in widely televised car crash rescue. Taught history in middle school before opening his own bike shop. Loves kids and has adopted two children.

Dane Jen—Secret agent for elite international police force. Known for solving complex mysteries in all parts of the world. Saved several famous works of art last year by busting international art theft ring.

Art E. Fact—Teenage history prodigy with photographic memory. Memorized every world capital by the time he was four. Started taking college history classes when he was 12. Loves soccer, rap music and reading ancient historical manuscripts.

Blaze Glory—Firefighter. Risked her life to save numerous works of art and other ancient relics in four-alarm fire last year. Advises world's top museums on fire safety and prevention. Winner of firefighting skills contest three years in a row.

Rex Plore 3000—Robot designed by International Committee on Extraterrestrial Threats to combat the Erasers. Equipped with cameras and high-speed hard drives to record huge amounts of historical data in seconds. Armor is made of new heat-resistant alloy that can withstand temperatures up to 800 degrees Fahrenheit.

The application includes missions in the following cultural and historical destinations. Additional sites in these cities as well as sites in Chicago, Philadelphia and San Francisco are contemplated;
New York City
   Metropolitan Museum of Art
   The Museum of Modern Art
   Natural History Museum
Washington D.C.
   Air & Space Museum
   Museum of American History
   National Gallery of Art
   Natural History Museum
Minneapolis
   Institute of Arts
London
   British Museum
   National Gallery
   Natural History Museum
   Tate Modern
   Tower of London
Paris
   Fontainebleau
   Louvre
   Notre Dame
   Sacre Coeur
   Versailles
Rome
   Colosseum
   Pantheon
   Roman Forum
   St. Peter's Basilica
   Vatican

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods, and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention. Those of ordinary skill in the art that have the disclosure before them will be able to make modifications and variations therein without departing from the scope of the invention. For example, GPS enabled device can allow the application to have real time access to the user's location within the site and the clues and information provided by the application can be tailored to the user's exact location.

1. A travel and educational process application for providing educational information relating to a site of interest, the process comprising:
providing a general purpose computer executing one or more computer instructions to carry out the steps of the method;
selecting a mission comprised of a series of steps for locating an artifact;
carrying out the series of steps;
answering questions related to the steps and artifact; and
completing the mission by finding the artifact.

2. The invention of claim 1 further comprising the step of selecting a difficulty level.

3. The invention of claim 2 wherein there are three difficulty levels based on the age appropriateness.

4. The invention of claim 3 wherein the levels are based on differing number of steps.

5. The invention of claim 1 further comprising the step of choosing an application persona.

6. The invention of claim 1 further comprising the step of taking an oath.

7. The invention of claim of claim 1 wherein the steps include providing directions to the artifact.

8. The invention of claim 1 further comprising the step of indicating that a step has been completed.

9. The invention of claim 1 further comprising the step of displaying an congratulatory screen upon accomplishing a step.

10. The invention of claim 1 further comprising the step of displaying an congratulatory screen upon accomplishing the mission.

11. The invention of claim 1 further comprising the step of assigning points based on the success of answering the question.

12. The invention of claim 1 further comprising the step of taking a photograph of a subject relating to the mission.

13. The invention of claim 12 wherein the subject if the artifact.

14. The invention of claim 1 further comprising the step of conveying information about the artifact.
